(19) United States
(12) Patent Application Publication
(10) Pub. No.: US 2019/0024524 A1
(43) Pub. Date: Jan. 24, 2019

(54) METHOD AND DEVICE FOR REDUCING LEAKAGE LOSSES IN A TURBINE

(71) Applicant: TURBODEN S. p. A., Brescia (IT)

(72) Inventors: Mario Gaia, Brescia (IT); Roberto Bini, Brescia (IT)

(73) Assignee: TURBODEN S. p. A., Brescia (IT)

(21) Appl. No.: 16/066,619

(22) PCT Filed: Jan. 18, 2017
(86) PCT No.: PCT/IB2017/050256

§ 371 Date: Jun. 27, 2018

(30) Foreign Application Priority Data
Jan. 20, 2016 (IT) 102016000004361

(51) Int. Cl. F01D 11/06; F01D 11/10

(52) U.S. Cl. CPC F01D 11/06; F05D 2260/2322; F05D 2240/55; F01D 11/10

(57) ABSTRACT

A method for reducing the leakage of an organic working fluid operating within a turbine (10) of an Organic Rankine Cycle system, the method comprising the injection of a fluid flow rate (Q) into a volume (I) at a static pressure lower than the total pressure (P1) upstream of the turbine and located near of at least one labyrinth seal (L1, L11) of at least one stage of the turbine (10), said fluid flow rate (Q) having an initial exergetic content lower than the initial exergetic content of the organic working fluid located inside the turbine and flowing through said labyrinth seal (L1, L11).

### RELATED APPLICATIONS

This is a national stage application of PCT application PCT/IB2017/050256 having an international filing Date of Jan. 18, 2017. This application claims foreign priority based on application Ser. No. 102016000004361 of Italy, filed on Jan. 20, 2016.

### BACKGROUND OF THE INVENTION

### 1. Field of the Invention

The present invention relates to a method and a device suitable to reduce the losses due to leakage of fluid in a turbine. The turbine is used for the expansion phase of steam thermodynamic cycles and is particularly suitable for an organic Rankine cycle (in the following, also an ORG cycle).

### 2. Brief Description of the Prior Art

As known, a finite sequence of thermodynamic (for example isothermal, isoc oric, isobaric and adiabatic) transformations, is defined as a thermodynamic cycle, at the end of which the system returns to its initial state. In particular, an ideal Rankine cycle is a thermodynamic cycle comprising two adiabatic transformation and two isobars, with two phase changes, from liquid to vapor and from vapor to liquid. Its purpose is to transform heat into work. Such cycle is generally adopted principally in thermal power plants for the production of electrical power and uses water as working fluid, both in liquid and vapor form, with the so-called steam turbine.

More specifically, organic Rankine cycles (ORG) have been designed and realized which use high molecular mass organic fluids for the most different applications, in particular also for the exploitation of thermal sources with a low-average enthalpy content. As in other steam cycles, the plant for an ORG cycle includes one or more pumps for supplying the organic working fluid, one or more heat exchangers to realizing the preheating, vaporization and possible overheating or heating stages in supercritical conditions of the same working fluid, a steam turbine for the expansion of the fluid, mechanically connected to an electric generator or a working machine, a condenser which returns the organic fluid in the liquid state and possibly a regenerator for recovering the heat downstream of the turbine and upstream, of the capacitor.

Particular attention is paid to the proper functioning of the turbine since the ORG efficiency, as well as also of a traditional water steam, cycle, greatly depends on the amount of mechanical work ‘which the turbine is able to process. One of the major sources of loss in a turbine is represented by internal leakages, or by the steam or gas flow rate which is not processed by the blades, due to clearance between stator and rotor parts.

One of the traditional ways to limit this type of losses consists in the adoption of labyrinths, or zones with reduced distance between the stator and the rotor parts, in which tortuous paths are also present in correspondence of said axial or radial clearances; in this way the flow rate of working fluid leaking from the clearances is limited by the load loss caused by the labyrinths. Different types of labyrinths are known, among which sliding or not sliding systems are mentioned, with or without honeycomb structures which can be abraded by sliding and other types of rigid structures but always consisting of abradable materials, or with very reduced cross sections in order to limit damages in case of a contact.

Labyrinth seals are an effective tool, but cannot cancel the leakages. The amount of fluid leakage depends on many factors (in particular on the involved pressures). Such leakage can correspond in some cases to 10% of the power produced by the turbine and is mainly localized in the first one or the first stages of the machines, where the pressures are higher and the blade heights are smaller: in fact, the same gap is more or less significant depending on the blade heights, as it has a different percentage ‘weight.

FIG. 1 is a detail of the high pressure stages of a axial turbine 1 according to the known art. As will be discussed below, however what will be explained later can be extended to any type of axial, radial (centripetal or centrifugal) or mixed radial/axial turbine. FIG. 2 shows a detail of the first stage, still according to the known art.

The vapor of the organic working fluid enters the turbine with the evaporation pressure PI. The vapor is accelerated in the first stator S1 and is guided towards the rotor blades RI, ‘where it generates mechanical power. The vapor pressure decreases from one stage to the other, until reaching at the exit of the turbine, a pressure value near to the condensation pressure. In particular, still in the first stator a strong reduction of the fluid pressure occurs: the relationship between the inlet pressure PI in the stator S1 and outlet pressure PI1 from the same first stator stage, can also be greater than 2, i.e. the stator works as a nozzle with a sonic block. As is known, the power associated to the decrease of the static pressure is converted in a dynamic pressure, i.e. in speed. In other words, between the upstream and downstream side of the stator, under adiabatic and isentropic conditions the total pressure (the sum of static and dynamic pressure) is preserved.

In such conditions, temperature and total enthalpy are also preserved in the stator, being by definition an adiabatic duct.

The accelerated vapor rate flow from the stator S1 will preferably move towards the rotor RI, but a portion of the same will directly flow downstream of the rotor RI by passing through the labyrinths L2 placed at the top of the blades and a portion (corresponding to the flow rate Qtₜaf) will instead flow through the labyrinths L1 placed closer to the axis of rotation. While the leakage occurring at. the top of the blades is not entirely “lost” as the fluid which “bypasses” the first rotor stage can still provide a mechanical work for the subsequent stages, the leakage through the labyrinths L1 is particularly severe when at the top of such labyrinths an upstream PI1 a downstream pressure Pcond are present, as it often occurs in practice (the leaked flow rate, leading directly to the capacitor can no longer produce a work).

Some solutions have been sought to the problem (which are cited for example in WO2014/191780 A1 and WO2012/052 740 A1) in order to reduce as much as possible the leakage losses from the turbine. In other words, instead of trying to L1 mit the leakage losses by reducing the flow rate of the leaked fluid, the present invention aims to reduce as much as possible the energy content of the exiting fluid exiting due to leakage.

### SUMMARY OF THE INVENTION

Aim of the present invention is to devise a method permitting to minimize the energy content of leakage losses of the organic fluid passes through the stages of a turbine and, consequently, to increase the efficiency of the turbine of a few percentage points.

The method according to the present invention uses a fluid injection in a vapor or liquid phase or in the form of a two-phase fluid and has the features referred to in the independent method claims.

The injected fluid may preferably be the same organic working fluid drawn from the same plant. The concept of the present invention, as will be seen below, can however be extended to any fluid.

Another aim of the present invention is to provide a device suitable to implement the above method by allowing to realize the fluid injection within the turbine in the most advantageous areas.

The device according to the present invention is integrated in the expansion turbine having the characteristics set out in the independent product claim.

A further aim of the present invention is to configure the ORG cycle plant or a traditional water vapor so that it is suitable to generate a flow rate of a working fluid, which is vaporized or is still in the liquid phase and can be injected into the turbine. This is done by providing the plant with an additional eat exchanger, as set out in the annexed plant claim.

Further ways of implement the aforesaid method and device, suitable to reduce the fluid leakage losses in a turbine, ‘which are preferred and/or particularly advantageous, are described according to the features set out in the annexed dependent claims.

### BRIEF DESCRIPTION OF THE DRAWINGS

The invention will now be described with reference to the accompanying drawings, which illustrate some examples of non-limiting embodiments, in which:

FIG. 1 is a detail of the high pressure stages of an axial turbine according to the known art,

FIG. 2 is a detail of the first stage of the turbine, still according to the known art,

FIG. 3 is the same detail of FIG. 2, shown with a split labyrinth,

FIG. 4 shows a detail of the first high pressure stage of a turbine, according to an embodiment of the present invention,

FIG. 5 shows a detail of the first high pressure stage of a turbine, according to a further embodiment of the present invention,

FIG. 6 shows a temperature-power diagram (FIG. 6a) and a temperature-entropy diagram (6b) of a typical organic Rankine cycle,

FIG. 7 is a thermodynamic temperature-entropy diagram in which different laminating curves of the liquid are shown, which are used to generate the steam, to be injected into the turbine,

FIG. 8 schematically shows a plant, with an ORG cycle (FIG. 8a) and its corresponding temperature-power diagram (FIG. 8b), according to a further aspect of the present invention,

FIG. 9 schematically shows a variant of the plant with an ORG cycle of the previous Figure (FIG. 9a) and its corresponding temperature-power diagram (FIG. 9b).

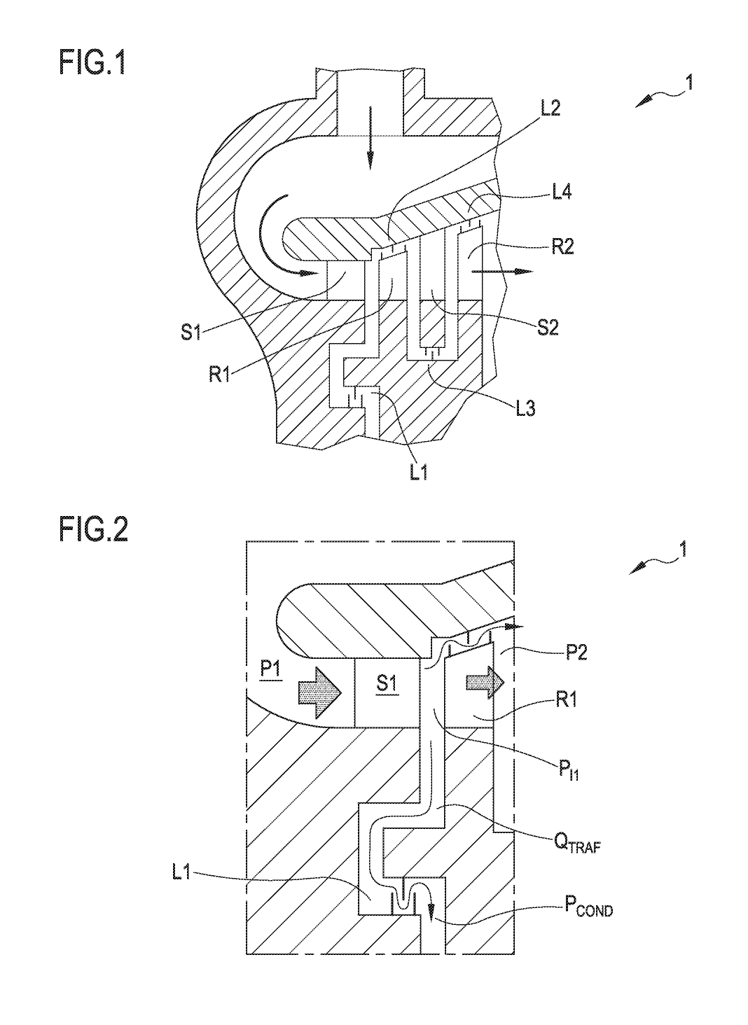

### DETAILED DESCRIPTION OF THE INVENTION OR OF THE PREFERRED EMBODIMENTS

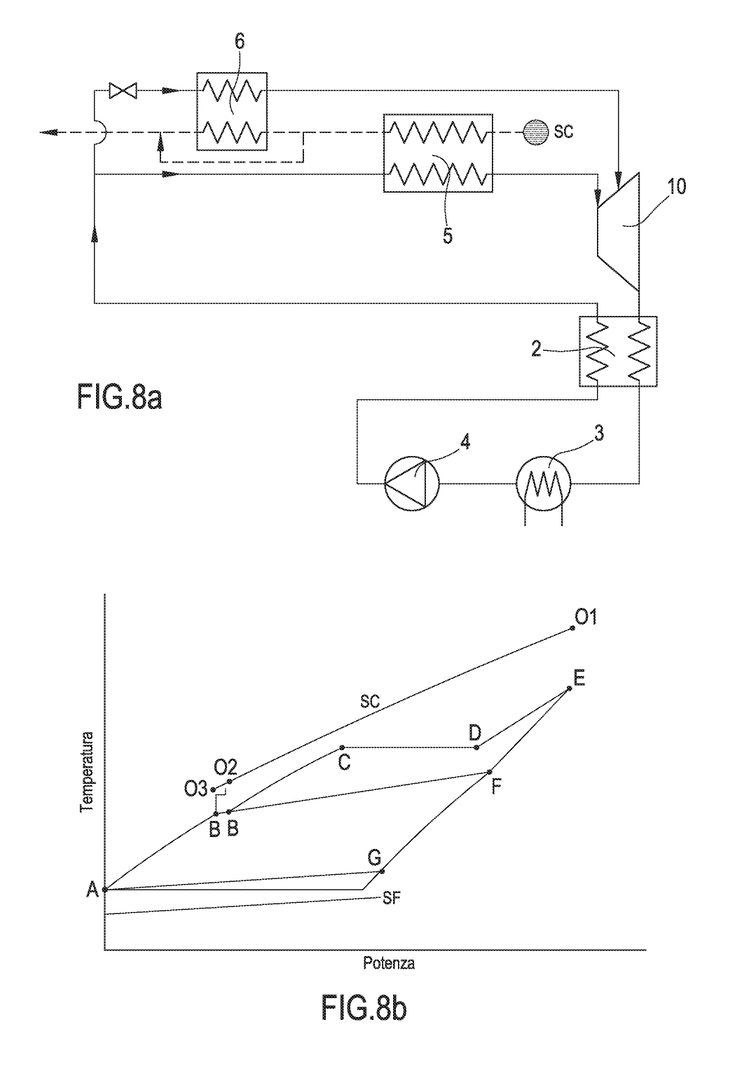

The invention relates to systems operating according to an organic Rankine cycle (ORG) or with a traditional water vapor as better explained at the end of the detailed description. In the following an ORG plant it more specifically described but similar arguments and conclusions can be obtained in the case of a traditional steam cycle. With reference to FIG. 8a which will be further described hereinafter for the purposes related to the present invention, a plant for ORG cycles, as is known, comprises at least a supply pump 4 for supplying an organic working fluid, in a liquid phase, to at least one heat exchanger 5. In the heat exchanger, ‘which in turn can comprise a pre-heater, an evaporator and a super-heater, the organic liquid is heated until its transformation in the vapor phase and until its eventual overheating or it is hypercritically heated in case of a supercritical cycle. The heat is supplied by a hot source, for example a diathermic oil. At the outlet from the heat exchanger, the steam passes through an expansion turbine 10 which produces the useful work of the cycle, i.e. the production of mechanical energy. The working fluid finally passes through a capacitor 3 which brings it in the liquid phase in order to be supplied again by the pump 4 to the heat exchanger. Advantageously, in order to increase the effectiveness of the cycle, between the turbine 10 and the capacitor 3 a heat recovery 2 can be inserted, i.e. a heat exchanger which exchanges heat between the organic fluid in liquid phase which is pumped by the pump 4 towards the heat exchanger 5, and the organic fluid in a vapor phase which from the turbine 10 is directed toward the capacitor 3.

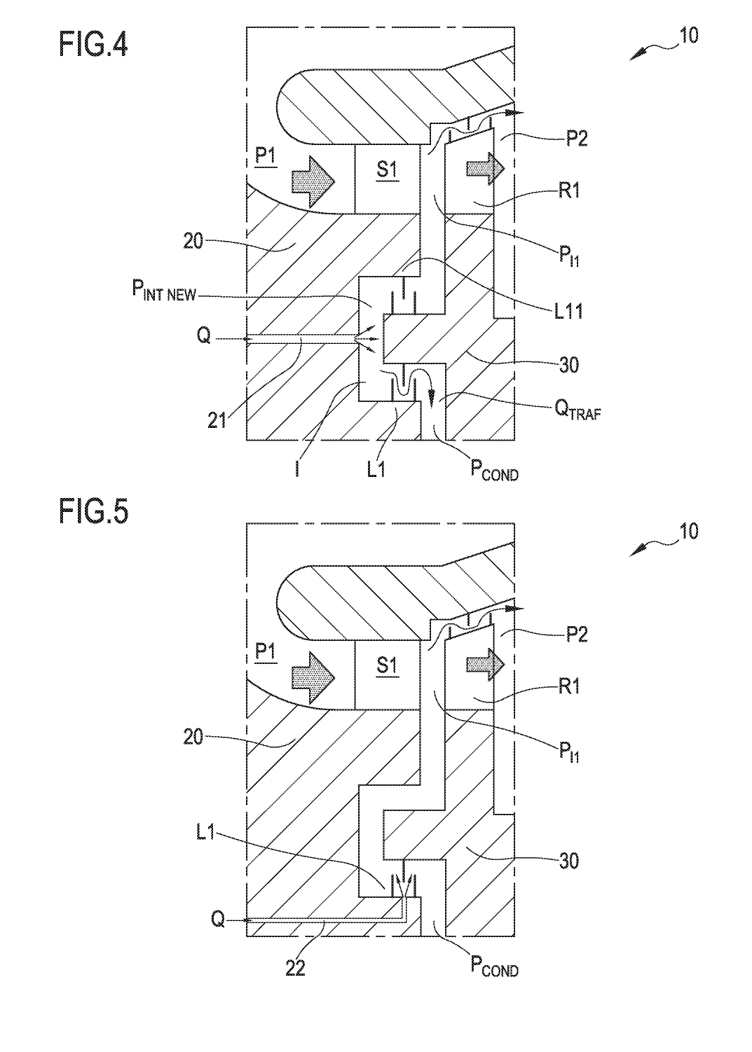

FIG. 4 shows a detail of the first high pressure stage of the turbine 10, according to one aspect of the present invention.

The turbine 10 then includes a first row of stators SI and a first row of rotors R1. The blades of the stator stage S1 are integral with the body 20 of the turbine, while the blades of the rotor stage R1 are integral with a disc 30 of the turbine. The same turbine 10 also may include further rows of stators and row of rotors and can also be an axial, radial (centripetal or centrifugal) or a mixed radial/axial turbine. The description of the method and of the device according to the invention will be referred purely by way of example to the first high pressure stage, as in FIG. 4, as this is the stage in which the fluid pressure is highest and therefore the losses due to leakage are more considerable in terms of loss of turbine efficiency. Naturally all can be said about the first turbine stage can also be implemented in one or more successive stages, also in correspondence of the labyrinths placed between the turbine case and the top of the rotor blades. The organic fluid at the turbine inlet, and hence upstream of the stator S1 stage has a total pressure P1, downstream of the same stator stage (i.e. upstream of the first rotor stage R1), will have a lower static pressure P11, whereas downstream of the first rotor stage R1, the fluid will have a further pressure reduction and the value of the static pressure is be equal to P2, then consequently P2<P11<Pi. The amount of the pressure reductions depends on the reaction of the turbine stage considered.

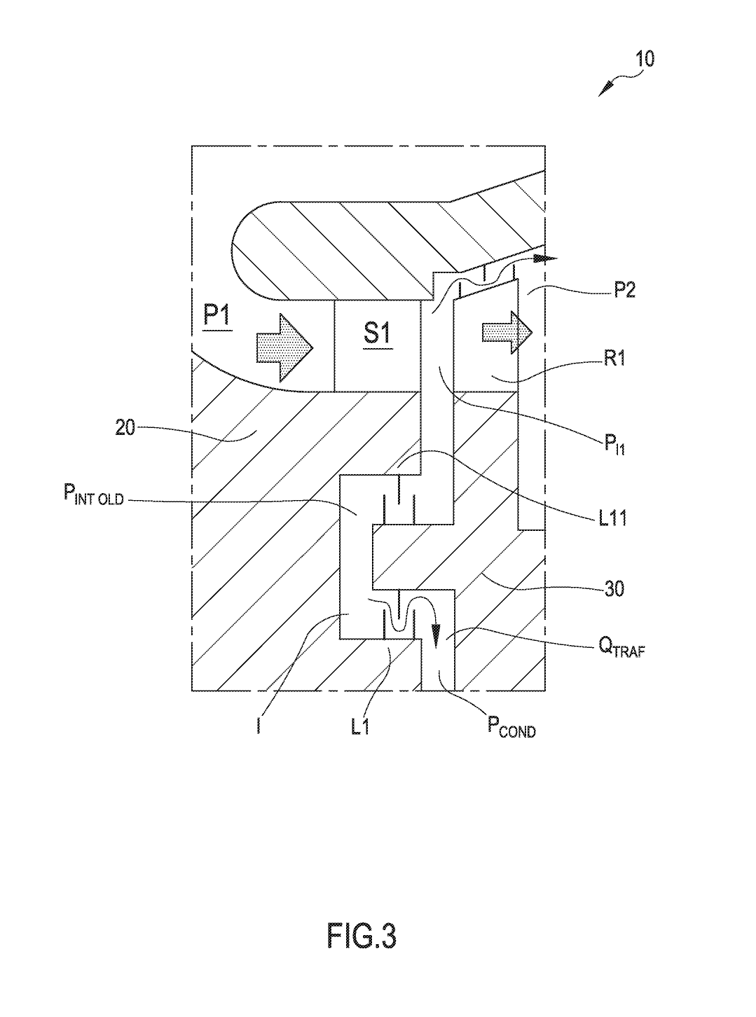

For the sake of simplicity, a labyrinth L1 is further considered, being identical to the L1 labyrinth (FIGS. 3 and 4), located upstream of L1. The volume between the two labyrinths will produce to a Pmto_{LD} pressure, which is intermediate between PI1 and Peon and is such that the flow rate of fluid leaking into the labyrinth between the PI1 and PincoLD pressures is equal to that leaking between the PintoLD and Pcond. Let's now assume that a volume I is supplied between the two labyrinths with a fluid flow rate Q. Advantageously, the same working organic fluid could be used, the flow rate of which can be tapped, according to known methods and therefore it will be not described. For reasons of clarity, let us also assume that the fluid is present in the form, of steam. The injection of fluid can take place by means of a duct 21 passing within the body 20 of the turbine. The volume I into which the fluid is injected will be at a static pressure lower than the total pressure PI upstream of the turbine.

Evidently if the volume in which the injection of the fluid flow rate Q occurs is placed in the vicinity of one stage of the turbine 10, different from the first stage, such a volume will be at a lower static pressure than the total pressure, upstream, of the corresponding rotor of the turbine stage in which the injection occurs.

If the pressure P_{intNBW} reached in Volume I is exactly equal to PI1, the labyrinth L1 will be traversed by a. vapor flow rate Qₜᵣₐf in practice identical to that which crossed it in the absence of the labyrinth L11, since the pressure difference upstream and downstream of L1 is the same as the case without injection (FIG. 2); also in this case the maze LII will not be affected by any pressure difference and thus will not be crossed by any vapor flow.

It is no ed that, the flow rate may not be exactly identical to Q_{craf} if the characteristics of the injected (superheated) steam were not identical to those present in the same room in the absence of injection. However, this does not alter in any case the meaning and the scope of the present invention.

If the injection pressure is greater than PI1 instead, there will be a flow also through LII, directed towards the blades. Viceversa, if the pressure is lower than P11, the flow rate crossing L11 will be directed towards the capacitor. A small flow rate through the labyrinth L11 is still desirable to flow and cool L11 in case you accidentally slide between the rotating part and the stator on.

In any case, the labyrinth L11 is subjected to a zero pressure difference Pₙ−Pj.ntNsw or otherwise a limited one, therefore L11 can be achieved with a less complex geometry with respect to L1.

With reference to FIG. 5, the injection can take place directly within the labyrinth LI, through a conduit 22 which also passes through the body 20 of the turbine, without the addition of a second group of labyrinths. Also, the injection can occur upstream of the single labyrinth L1.

It is now necessary to consider that, according to the present invention, it is possible to generate steam of fluid (or working organic fluid) to be injected in the labyrinths in such a way that such a steam, is generated with a lower energy original content (as it is known, the energy of a system is the maximum fraction of energy that can be converted into mechanical work) lower than that of the steam flowing through the labyrinth traditional turbine, so as to obtain a higher yield of the turbine and the overall thermodynamic cycle.

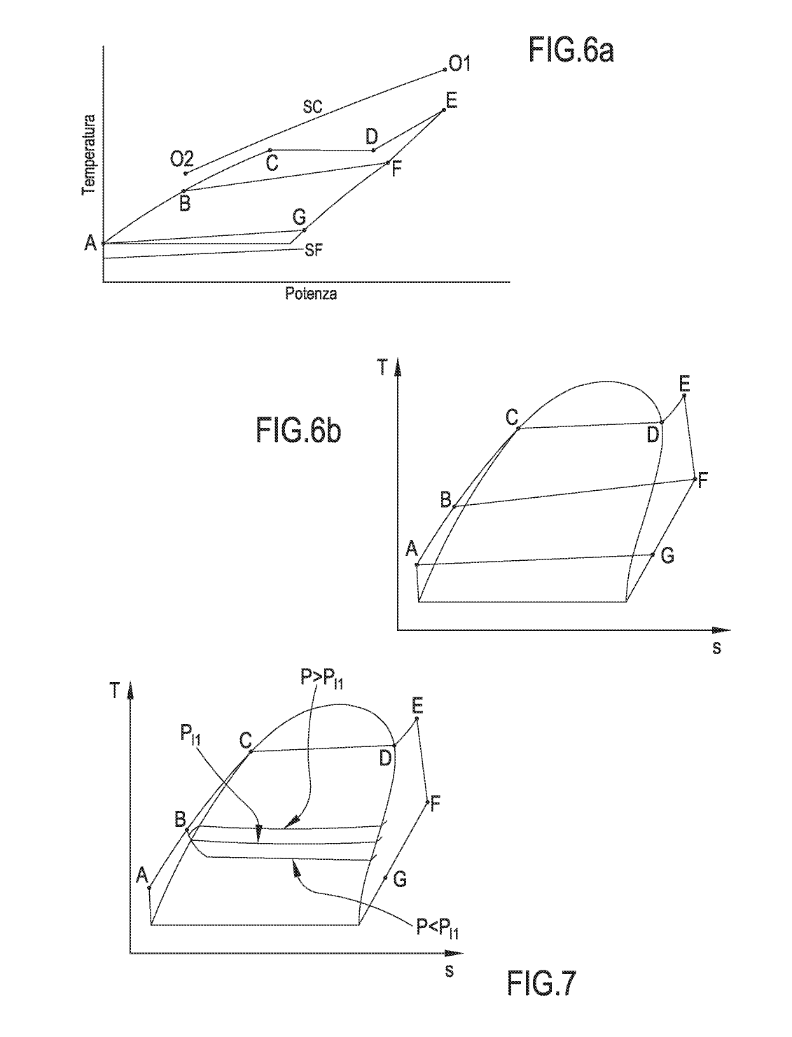

In FIG. 6 it is shown the temperature-power diagram

(FIG. 6a) and the temperature-entropy (6b) of a typical ORG cycle. As it is known, the organic fluid receives heat from the high temperature source SC that consequently will lower its temperature, accomplishing the transformation thermodynamics from 01 to 02. In particular, the SC source releases heat, to the organic fluid in BC (p e-heating), CD (evaporation) and D-E (overheating). The hot source can be diathermal oil or directly geotermal fluid or the combustion or recovery gases of water vapor. The turbine expands the fluid in EF, while the heat released in FG is transferred to AB (regeneration), if a regenerator is present in the cycle. The further heat possessed by organic fluid is then transferred to a cold source SF (condensation).

The injection of the organic working fluid in the labyrinths can be made according to three different modes, all selected so as to obtain the desired improvement in performance of the turbine:
first mode: injection of steam, to a pressure level Pinc_{NE}w, next to the one present downstream of the first turbine stator (ie Pint_{NE}^{3/4} P n;
second mode: injection of working fluid in the liquid state with generation of steam in the vicinity of the labyrinths;
third mode: injection of working fluid in the liquid state with the generation of a two-phase mixture in the vicinity of the labyrinths.

For simplicity reasons, in the following description, the embodiment will be considered with the single labyrinth L1 (as shown in FIG. 5), where the same considerations will be obviously applicable also in the case there is the presence of an additional labyrinth L11 (as illustrated in FIG. 41.

The first mode provides an injection into the steam labyrinth to a next pressure PI1, i.e. the pressure downstream of the first stator; the steam at this intermediate pressure is generally not available and must be specially generated, A solution is to draw off the organic fluid still in the liquid phase, for example at the outlet of regeneration B, laminate it and allow it to evaporate at a lower pressure in an additional heat exchanger (6 in FIG. 8a), by exploiting in the most convenient way the hot source SC.

The steam production to an intermediate pressure level (for example equal to PI1) involves the absorption of a considerable power, but still at a lower temperature compared to the upstream steam turbine conditions with a pressure PI. The steam upstream, of the labyrinth L1 is in both cases (with and without injection) near to the static pressure P11, but in the case without injection it is located at a higher total enthalpy level, almost equal to that in the turbine inlet. Hence, the steam used to “seal” the labyrinth has an energy content (total enthalpy) lower than that of the steam that leaks normally from the labyrinth. Furthermore, the power produced for the steam at the turbine inlet conditions (point E in FIG. 6) is greater than that required to produce the same amount of steam to the pressure PI1: for example, if the point E is 250° C. and 25 bars and the working fluid is cyclopenthane, the enthalpy difference from the point B (liquid at 25 bar, 130° C.) necessary to produce respectively superheated steam in the conditions of the point E and saturated steam at a pressure equal than PI1, for example at 12 bar is 530 kJ/kg compared with 350 kJ/kg.

FIG. 7 is still a thermodynamic temperature-entropy diagram in which in addition to ORG cycle already illustrated in FIG. 6b are different possible choices of the lamination pressure are shown, at which to generate the steam to be injected. The choice of the lamination pressure PincNEw with respect to PI1, or if equal to PI1 or slightly higher or slightly lower is conditioned by the balancing of several factors:

the higher the pressure, the lower the flow of “precious” steam which leaks from, the outlet from the stator to the condenser, but this implies the need to produce the “auxiliary” steam at a higher temperature (FIG. 7, P_{intNEK}>PI1);
the more the pressure is low, the higher is the possibility that the “fine” steam can leak towards the condenser, but it is possible to produce the “auxiliary” steam at a lower temperature.

The level of laminating pressure in fact determines the overall efficiency of the plant.

In fact, if the liquid is evaporated at a sufficiently low temperature, it is possible to further lower the temperature of the hot source (from 02 to 03), and then recover more heat, as described in FIGS. 8a and 8b. In this case, the low pressure steam generation can be realized by an additional heat exchanger 6, fed downstream of the main heat exchanger 5.

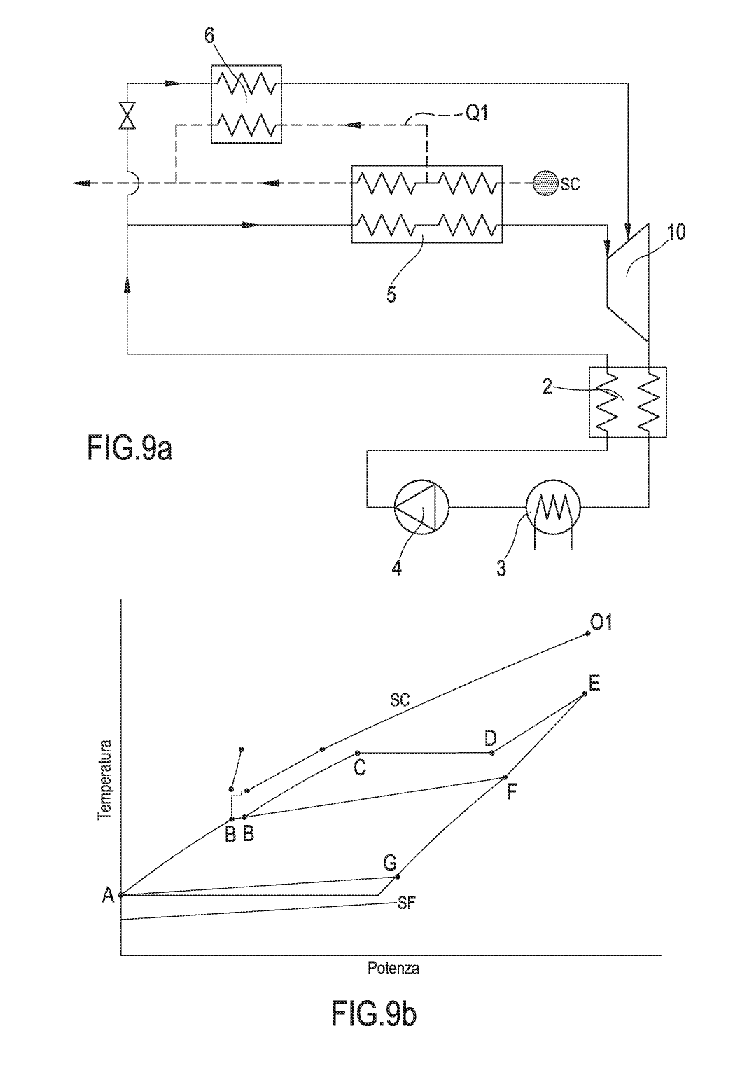

Alternatively, with reference to FIG. 9, a certain flow rate QI of oil can be separated from the main circuit to a suitable intermediate temperature (in the example below about 200° C.) and with it in parallel with the additional heat exchanger 6.

The solution of FIG. 9 is required when the oil temperature 02 is already very low (such as not to allow further heat recovery) or ‘when the dimensioning of the additional heat exchanger 6 according to the diagram of FIG. 8 would lead to very large surfaces of exchange (in fact, according to the scheme of FIG. 9, the difference in temperature in the heat exchanger increases, then for the same power the exchanger has lower sizes and costs.

Table 1 shows the performance increase that can be achieved thanks to the subject of the patent system in a typical case of ORG application. The standard case (without application of the present invention, that is, according to the known art) refers to a plant of cyclopenthane, as represented in FIG. 6. The other two cases instead refer to the same plant in which the injection system has been implemented in the labyrinths, respectively according to the diagrams of FIGS. 8 and 9. The steam turbine inlet conditions are 25 bar and 250° C., while the pressure PI1 in this example is equal to 12 bar; the hot spring is diathermic oil to 315° C.

TABLEa 1
Property Standard Injection (FIG. 8) Injection (FIG. 9)

Texit oil (° C.) 161 156 158
Total thermal 22215 22787 22719
absorbed power (kW)
Extra power 2.3 2.8
absorbed for generation of
steam to be
injected (%)
Gross 4801 5016 4973
electrical
power generated
(kW)
Gross 21,6 22, 0 21,9
efficiency (%)

In the cited examples, the thermal power absorbed by ORG in cases with injection increases, but the increase of generated electric power is greater than that obtained with a simple increase in plant size, therefore the performance of the cycle increases.

Another way to highlight the efficiency of the system is to evaluate the increase of electric power obtained in relation to the increase of required thermal power. In the cases referred to the above example:

TABLE 2
Inj ect.ion FIG. 8 Injection .g. vs standard s standard

Δ Thermal power + 572 + 504
(kW)
Δ Electric power + 215 + 172
(kW)
Electric 37, 6 34, 1
efficiency of the
added part

The performance values of the added power section are therefore clearly superior to the performance of the basic cycle (˜35% vs ˜21%),

The second mode of generation of steam at lower pressure provides that the organic liquid is withdrawn in liquid form in the most convenient point in the system, and injected into the labyrinth, ‘where it tends to evaporate because it absorbs heat from the hot walls of the turbine, but especially by the steam already present in the chamber: the liquid impacting against the rotating surfaces tends to be distributed in form of drops that increase the thermal exchange surface with the surrounding steam.

The evaporating fluid increases its volume and the pressure inside the chamber, limiting the leakage. The advantage compared to the previous mode is that it uses fluid in the liquid state and not steam, hence with a lower energy content. The disadvantage may be represented by the tensional stress that may be created in the material forming the stator and rotor components in localizing lowering of temperature due to the introduction of cold liquid. Furthermore, the organic fluid may leak out of the labyrinth still in the liquid state, segregating in certain areas of the turbine or impacting on downstream blades.

The third mode of the steam generation instead takes its cue from what has just been described as a possible disadvantage of the previous mode: the liquid is injected in the chamber delimited by the labyrinth, so as to spread, in form of droplets; part of the fluid evaporates, while another part remains in a liquid form. This mixture of steam and drops will tend to flow more laboriously through the labyrinths games, limiting the leakage.

For example, the labyrinth L1 is typically affected by a difference pressure highly above the critical pressure ratio, then the steam that leaks will have a sonic speed equal to that in the vicinity of the minimum passage section. If to the vapor liquid droplets are united, these obstruct the passage of vapor in the vicinity of the throat, reducing the passage area for the steam.

The presence of drops decreases the steam leakage, but the total flow exits the labyrinth increases because the liquid phase is approximately a thousand times more dense than steam: in general you can still have an advantage due to the fact that the liquid phase is energetically “poorer”.

In addition to the modes of the invention, as described above, it is to be understood that there are many further variants. It must be understood that these modes of implementation are only illustrative and do not limit the invention or its applications, nor its possible configurations. On the contrary, although the description above makes it possible to man craft of the implementation of the present invention at least one of its second configuration example, it should be understood that numerous variations are conceivable of the components described, without moving away from the object of the invention, as defined in the appended claims, interpreted literally and/or according to their legal equivalents.

The invention relates to systems that operate according to an organic Rankine cycle (ORG) or traditional water vapor, in particular to the case where the expansion ratio around the object considered is at least 1.5, in a manner that the energetic content of the steam injected to the labyrinth becomes significantly lower than that of the ma in flow in correspondence of that stage.

1. A method for reducing the leakage of an organic working fluid operating within a turbine (10) of an Organic Rankine Cycle system, the method comprising the injection of a fluid flow rate (Q) into a volume (I) at a static pressure lower than the total pressure (PI) upstream of a turbine and located near of at least one labyrinth seal (L1, L11) of at least one stage of the turbine (10), said fluid flow rate (Q) having an initial exergetic content lower than the initial exergetic content of the organic working fluid located inside the turbine and flowing through said labyrinth seal (L1, L11).

2. The method according to claim 1, wherein said volume (I) is accommodated close to the first stage of the turbine (10).

3. The method according to claim 1, wherein the volume in which the injection of the fluid flow rate (Q) takes place, is accommodated close to one stage of the turbine (10) different from the first stage and is at a lower static pressure with respect to the total pressure upstream of the corresponding turbine stage in which the injection takes place.

4. The method according to claim 1, wherein said fluid flow rate (Q) is injected exactly inside a first labyrinth seal (L1).

5. The method according to claim 1, wherein said fluid flow rate (Q) is injected upstream of the first labyrinth seal (L1).

6. The method according to claim 1, wherein said fluid flow rate (Q) is injected into the volume (Ï) upstream of the first labyrinth seal (LI) and downstream of a second labyrinth seal (L11).

7. The method according to claim 1, wherein said flow rate (Q) of the organic working fluid is injected in a vapor phase.

8. The method according to claim 1, wherein the said flow rate (Q) of the organic working fluid is injected in a liquid phase.

9. The method according to claim 8, wherein the flow rate (Q) of the organic working fluid vaporizes close to said at least one labyrinth seal (L1, L11).

10. The method according to claim 8, wherein said flow rate (Q) of the organic working fluid is transformed into a two-phase mixture close to said at least one labyrinth seal (L1, L11).

11. The method according to claim 10, wherein the said flow rate (Q) of the organic working fluid is generated downstream of a recuperator (2) of the ORC plant.

12. The method according to claim 11, wherein said flow rate (Q) of the organic working fluid is tapped in liquid phase downstream of the recuperator (2), and then is laminated and finally is vaporized in one additional heat exchanger (6).

13. An expansion turbine (10) comprising:
a housing (20) steadily connected with at least a first stator stage (S1);
at least one disk (30) steadily connected with at least a first rotor stage (R1);
at least one labyrinth seal (L1, L11) located downstream of said at least one first stator stage;
and further comprising at least one duct (21, 22) that fluid connects the exterior of the turbine with the inner volume of the turbine and that is configured to inject a flow rate (Q) of a fluid close to said at least one labyrinth seal (L1, L11), said fluid flow rate (Q) having an initial exergetic content lower than the initial exergetic content of the organic working fluid located inside the turbine and flowing through said labyrinth seal (L1, L11), said fluid flow rate (Q) having a static pressure lower than the total pressure (P1) upstream of a stage wherein the injection takes place and an initial exergetic content lower than the initial exergetic content of the organic working fluid located inside the turbine and flowing through said labyrinth seal (L1, L11).

14. The expansion turbine according to claim 13, wherein said fluid flow rate (Q) is injected through a first duct (22) exactly inside the first labyrinth seal (L1).

15. e expansion turbine according to claim 13, wherein said fluid flow rate (Q) is injected through the first conduit (22) upstream of the first labyrinth seal (L1).

16. The expansion turbine according to claim 13, wherein said fluid flow rate (Q) is injected through a second conduit (21) in the volume (I) upstream of the first labyrinth seal (L1) and downstream of a second labyrinth seal (L11).

17. An Organic Rankine Cycle (ORC) system, comprising:
a recuperator (2) configured to transfer heat from an organic working fluid in a vapor phase to the same organic working fluid in a liquid phase;
a condenser (3) downstream of the recuperator (2) configured to transfer heat from the organic working fluid in a vapor phase to a cold source (SF);
pumping means (4) downstream of the condenser (3) configured to feed the organic working fluid in a liquid phase to a heat exchanger (5) at a predetermined pressure (PI);
a heat exchanger (5) configured for heating, vaporizing and eventually overheating the organic working fluid by means of a hot source (SC);
an expansion turbine (10) configured to expand the organic working fluid in a vapor phase from a pressure (PI) to a lower pressure (Pcond).

18. The Organic Rankine Cycle system according to claim 17, comprising an additional heat exchanger (6), downstream of the heat exchanger (5) and configured to vaporize by means of the hot source (SC) a flow rate (Q) of the organic working fluid, tapped in liquid phase downstream of the pump (4) or the recuperator (2).

19. The Organic Rankine Cycle system according to claim 18 wherein said additional heat exchanger (6) is crossed by a fraction of the hot source (SC) flow rate.

20. Organic Rankine Cycle system according to claim 17, wherein said additional heat exchanger (6), placed in parallel to at least a portion of the heat exchanger (5) and configured to vaporize by means of the flow rate (Q1) of the hot source (SC) a flow rate (Q9 of the organic working fluid, poured in a liquid phase downstream of the pump (4) or of the recuperator (2).

21. The Organic Rankine Cycle system according to claim 17, wherein said turbine (10) comprising:
a housing (20) steadily connected with at least a first stato stage (S1);
at least one disk (30) steadily connected with at least a first rotor stage (R1);
at least one labyrinth seal (L1, L11) located downstream of said at least one first stator stage;
and further comprising at least one duct (21, 22) that fluid connects the exterior of the turbine with the inner volume of the turbine and that is configured to inject a flow rate (Q) of a fluid close to said at least one labyrinth seal (L1, L11), said fluid flow rate (Q) having an initial exergetic content lower than the initial exergetic content of the organic working fluid located inside the turbine and flowing through said labyrinth seal (L1, L11).

22. The Organic Rankine Cycle system according to claim 17, wherein said turbine (10) is characterized by the fluid flow rate (Q) being injected through a first duct (22) exactly inside the first labyrinth seal (L1).

23. The Organic Rankine Cycle system according to claim 17, wherein said turbine (10) is characterized by the fluid flow rate (Q) being injected through the first conduit (22) upstream of the first labyrinth seal (L1).

24. The Organic Rankine Cycle system according to claim 17, wherein said turbine (10) is characterized by the fluid flow rate (Q) being injected through a second conduit (21) in the volume (I) upstream of the first labyrinth seal (L1) and downstream of a second labyrinth seal (L11).
